(19) United States
(12) Patent Application Publication
(10) Pub. No.: US 2005/0125260 A1
(43) Pub. Date: Jun. 9, 2005

(54) Method for quoting and contracting for management of inputs and services under a commercial service agreement, with a service loss guaranty or insurance policy and using an information management system

(75) Inventors: Thomas A. Green, Madison, WI (US); Thomas J. Buman, Carroll, IA (US); Stanley Buman, Carroll, IA (US); Brian Brandt, Columbus, OH (US)

Correspondence Address: CHAPMAN AND CUTLER, 111 WEST MONROE STREET, CHICAGO, IL, 60603, US

(73) Assignee: Agflex, Inc., Madison, WI (US)

(21) Appl. No.: 10/730,509

(22) Filed: Dec. 8, 2003

(51) Int. Cl. G06F 17/60

(52) U.S. Cl. 705/4

(57) ABSTRACT

A method is provided for use of an information management system to produce quotations and related information on optimized inputs and services for the production of food, feed, fiber, livestock, and the like, and to execute customized commercial service agreements including a performance guaranty or insurance policy. The system includes a database of historical input and service performance and a decision support system to optimize future performance. The commercial service agreement includes protocols for applying inputs, performing services, and assessing performance. Related information includes input management plans; savings, rebate or cost-share information, applications or credits; information or forms for permits or regulatory compliance; and emissions trading credits or executed trades. The system administers a remedy if performance standards are not met. This method has broad application to plant and livestock production in reducing nutrient and pesticide inputs and pollution, and in reducing economic risks for producers and input/service providers.

### FIELD OF THE INVENTION

The present invention relates generally to farming and production methods for selecting and applying inputs, such as pesticides, fertilizers, feed supplements, and seed, and providing services, such as monitoring, sampling, recommending, or applying custom inputs or tillage, that optimize long-term farm production results and provide a remedy if performance fails to meet specified standards.

### BACKGROUND OF THE INVENTION

In the agricultural production of food, feed, fiber, ornamental plants, dairy products, livestock, and the like, inputs are often overused to avoid less-than-optimum production outcomes. Such overuse of inputs, however, has well-documented negative impacts on water supplies, environmental quality, and human health. Historically, farmers have routinely over-applied inputs as “insurance” to guaranty maximum yields.

Over the past 30 years, however, a large public investment has created hundreds of Best Management Practices (“BMPs”) designed to help farmers apply these inputs only when they will generate a net economic return. These BMPs, including Integrated Pest Management (IPM) systems, optimize production returns over time, but may not provide maximum production and income in any one year. Further, most BMPs are designed to apply to an entire state or to a group of states and are not customized to specific locations or fields within those large areas. BMPs also typically are not continuously refined, because no system exists for assessing performance when a BMP is actually used.

BMPs are also not widely adopted in large part due to risk. BMPs can reduce yields in years when rare, unpredictable weather events occur. Most farmers will not accept those occasional relative losses, even though BMPs will save them money over time. Newly developed and newly modified BMPs are perceived by many farmers to be more risky than they actually are, simply because they are new.

Input sellers and service providers who recommend or implement BMPs lose input sales revenue when BMPs are used and risk loss of customers when BMPs fail relative to those not using BMPs. Therefore, very few input and service providers recommend BMPs. Most farmers rely on input sellers and service providers as their primary source of advice on how much and what types of inputs to purchase and apply and for what services to use, and when.

Current crop and livestock insurance policies typically do not cover losses due to BMP failures, because of their high deductibles. Most losses arising from BMP failures are small and well within those deductibles.

One insurance policy specifically designed to cover BMP failure is known to exist; that policy, a pilot federal crop insurance endorsement, is available only to corn farmers in four states (IA, MN, PA, and WI) who plant non-irrigated corn for harvest as grain, following a crop other than corn, and who also purchase one of two types of federal crop insurance (Multiperil or Crop Revenue Coverage) policies. Only one of these endorsement policies was sold in its first year of availability, and that one covered just 10 acres. Only one of the 14 crop insurance companies eligible to offer the BMP endorsement is doing so.

One input and service provider is known to provide a guaranty of a “clean, marketable crop” to a select group of customers who follow its recommendations. That guaranty does not provide an objective measure of input or service performance and an IMS is not used to monitor and track performance, develop quotes, prepare and execute a commercial service agreement or provide related information.

By calling for reduced inputs, BMPs have been proven to reduce pollution including contamination of water supplies with pesticides and nutrients. For example, excess nutrient use in the Mississippi River watershed or basin has been blamed for the large “dead zone” observed in the Gulf of Mexico, caused directly by hypoxia (lack of oxygen in the water). Experts estimate that BMPs, if widely adopted, could reduce nutrient use in the Mississippi basin by 40%, which is also the reduction called for by gulf water experts to eliminate that dead zone.

Numerous entities with vested interests in reducing pollution, including government agencies and private stewardship groups, offer financial incentives for input users to follow BMPs. These incentives include cost sharing, rebates, subsidies, and tax credits.

No information management system (IMS) in food, feed, or fiber production is known that is designed to identify or secure these potential opportunities to minimize or defray costs.

An increasing number of regulatory agencies also require conformance with BMPs to obtain permits to operate facilities such as for livestock production, or to use potentially polluting inputs such as fertilizers.

No IMS in food, feed, or fiber production is known that is designed to identify these requirements, to prepare applications, or to document compliance as part of the transactions for purchasing regulated inputs or services.

Emissions credit trading markets for greenhouse gases responsible for global warming may also provide an opportunity for BMP users to defray the cost of implementing BMPs. The Chicago Climate Exchange initiated greenhouse gas emissions credit trading with the first auction in September of 2003; continuous trading is anticipated to commence in December 2003.

No IMS is known that is designed to identify trading opportunities available to individual food, feed, fiber, or livestock producers, to prepare applications, or to execute trades as part of transactions to purchase regulated inputs or services.

The following is an example of problems seen in the current state of the art:
The average corn producer in Wisconsin applies 38 lbs. more nitrogen and 75 lbs. more phosphorus per acre per year than would be applied under BMPs published by Wisconsin state agencies. In most years, these extra nutrients are not needed, and at the smaller, BMP rates of application these inputs will produce the same yields. However, at BMP rates, yields may fall short of maximum potential in years when excessive spring rains cause nutrients to leach through the soil or wash away in runoff. BMP yield may also fall short of maximum in years when ideal growing conditions occur and the corn crop can take advantage of more nutrients than are made available. In addition, in specific areas of the state, published BMPs are generally known by crop advisors and producers to fail more often than in other areas due to local soil types and weather conditions there. State experts do not have a facility to monitor performance in all areas of the state and to make appropriate adjustments to the published BMPs for those areas.
Average nutrient application rates to corn in Wisconsin are above BMP rates because most farmers will not accept occasional reduced yields, despite the fact that BMP rates of application will save them money over the course of several years. Wisconsin has enacted new regulations requiring, by 2008, each farmer in the state to create and implement a nutrient plan, using BMP rates of nutrients. The state has no IMS to record or audit these plans, however. Several federal, state, and local programs in Wisconsin offer cost sharing for farmers to use nutrient BMPs, but no IMS is available to identify and secure these opportunities. Emissions credit trading opportunities are not yet available to individual corn farmers in Wisconsin.
Wisconsin corn farmers have multiple additional opportunities to reduce inputs, costs, and pollution including IPM sampling and monitoring techniques for reducing pesticide use for corn rootworm, black cutworm, wireworm, and other insect pests and diseases; for reducing herbicide use with half-rate applications coupled with accurately timed, light cultivation; and for reducing soil erosion through reduced tillage techniques. No IMS exists to manage these multiple opportunities, to help replace input sales revenue lost to input and service providers, or to reduce risk of failure to both producers and input/service providers.

Accordingly, there is a need in the art for an improved method for increasing producers' adoption of BMPs in their production of corn and other food, feed, fiber, and livestock. An efficient IMS is needed to address and quantify economic risks to producers and to input sellers and service providers, and to continuously improve the efficacy of BMP systems.

### SUMMARY OF THE INVENTION

A commercial service agreement that specifies the inputs and/or services to be provided, procedures to be followed, and expected performance standards can include a guaranty or insurance policy that reduces or eliminates the risk to the input seller or service provider and to the producer. The cost of the guaranty or insurance policy can be determined by examining and analyzing data on the performance of the input or service over time in a variety of circumstances and conditions. Input and service providers who offer the guaranteed or insured commercial service agreements to their customers can protect themselves from risk, and earn revenue from sales of the agreement and optimized inputs and services related to execution of the service agreement. These revenues can replace those lost by reducing sales of inputs. One such commercial service agreement, created by the present inventors, will be piloted in 2004.

An IMS would greatly improve the efficiency of managing inputs and services according to BMPs. This management would include estimating expected losses due to BMP failure; quoting prices for inputs, services, and performance guaranties; generating and executing commercial service agreements; generating required forms and applications; processing claims and issuing payments or other remedies for BMP-related losses; continuously improving decision-support systems designed to optimize inputs and services; and continuously refining the accuracy of loss estimates.

A method is provided for use of an information management system (IMS) to deliver quotes for inputs and/or services to a producer or manager of any of food, feed, fiber, ornamental plants, and livestock, to deliver related information, and to execute a customized commercial service agreement for providing those inputs and/or services. The service agreement includes a service loss guaranty or insurance policy on the performance of those inputs and/or services.

The IMS includes a host computer system housing or linked to a database or databases of historical input and service performance data from a plurality of producers in an area of interest. These data will include those developed and published by researchers at universities and in industry, as well as new data generated from users of the system. The host computer system may include or be linked to one or more decision support systems designed to determine the optimum application of inputs and/or services.

A customized quote for inputs and/or services and any related information is generated by the IMS based on historical data contained in the database, information contained in the decision support systems, and general and site-specific information provided by the producer, manager and/or input or service provider in their request for a quote. This customized quote and information is transmitted to the producer, manager, or input/service provider in the form of a commercial service agreement.

The commercial service agreement includes a protocol for applying the inputs and performing the services, and a protocol for assessing service losses to be covered by the service loss guaranty or insurance policy. The related information provided to the producer or input/service provider may include input management plans; savings, rebate or cost-share information and/or application forms; information or forms to document applications for permits or compliance with regulations; and available emissions trading credits or executed emissions credit trades.

The IMS allows performance data to be entered, stored and applied to effect continuous improvement of the BMP systems recommended, accuracy of expected loss estimates and price quotes.

### BRIEF DESCRIPTION OF THE DRAWINGS

FIG. 1 shows a flow chart of the present invention.

FIG. 2 shows a relational diagram of steps of the present invention.

### DETAILED DESCRIPTION OF THE INVENTION

A wide variety of inputs are generally used in the production of plants and animals, to improve production performance. These inputs include nutrients required by the production for growth and development; pesticides and medications to reduce injury from insect, mite and nematode pests, diseases and weeds; amendments to soil such as lime and organic matter to improve soil condition; and growth regulators such as plant or animal hormones to accelerate or otherwise modify production. Often these inputs are inexpensive relative to the value of the production. For example, a pesticide application to an acre of apple trees may cost $20 vs. $7500 for the value of the apple crop produced on that acre. Unnecessary or excessive applications of inputs are often viewed by producers and input suppliers as “cheap insurance” and so are applied regardless of true need for the coming growing season, which is typically difficult to predict with certainty. However, by over-applying inputs, producers increase costs, reduce income, increase risks to human health, and pollute the environment.

In addition, a variety of mechanical operations are used to improve production performance, such as tillage or cultivation, pruning, controlled burning of vegetation, and mechanical application of inputs. Often specific protocols are designed to implement these mechanical operations, or new mechanical operations and equipment are developed, to optimize performance of the production and/or to minimize impacts on human health and the environment.

A large public investment has been made in the development and recommendation of a broad array of Best Management Practices (BMPs) and other scientific practices developed for many specific types of production. These practices are designed to improve economic outcomes over time, in many cases by minimizing inputs most often including nutrients and pesticides, but also including fuel and personnel time. These practices are well established in theory and often are well proven in research trials on small plots; less often they are proven in on-farm, field-sized trials.

Unfortunately, BMPs and other scientific practices that are designed to optimize economic performance and improve impacts on health and the environment over time may result in short-term losses in any single time period such as one growing season. For example, a corn grower in Wisconsin may typically apply 160 lbs. of commercial nitrogen fertilizer at a cost of $14 per acre, when state agencies recommend a BMP rate of 120 lbs., after crediting the nitrogen contribution from a preceding crop of soybeans. Additionally, the farmer may apply 75 lbs. of phosphorus fertilizer at a cost of $18.75 per acre, when the BMP recommendation may be that none is needed. By following the BMP rates for these nutrients, the farmer saves $22.27 per acre in fertilizer cost and in most years will generate the same yield of corn. However, in some years, as when spring rains cause some of the nitrogen to be lost to leaching and runoff, the yield may be less when the BMP rate is applied. At a price of $2.25 per bushel, any yield shortfall greater than 10 bushels per acre would create a short-term economic loss. This event may occur only once in ten years, during which a net economic gain of $200.43 per acre would have been earned (9 times $22.27). Most farmers will not accept a short-term loss to obtain the long-term gain. The Economic Research Service of USDA estimates that 47.4 million acres of corn receive at least 25% more nitrogen than is normally needed and called for by BMP.

Performance data for nitrogen and phosphorus BMPs for corn indicate average expected loss in a peak-production year of $6 per acre. A performance guaranty priced at $12 per acre could preserve $10.27 of the fertilizer savings annually, and restore a neutral economic return in the one year in ten that yields at BMP fertilizer rates fail to meet yields at the higher rate.

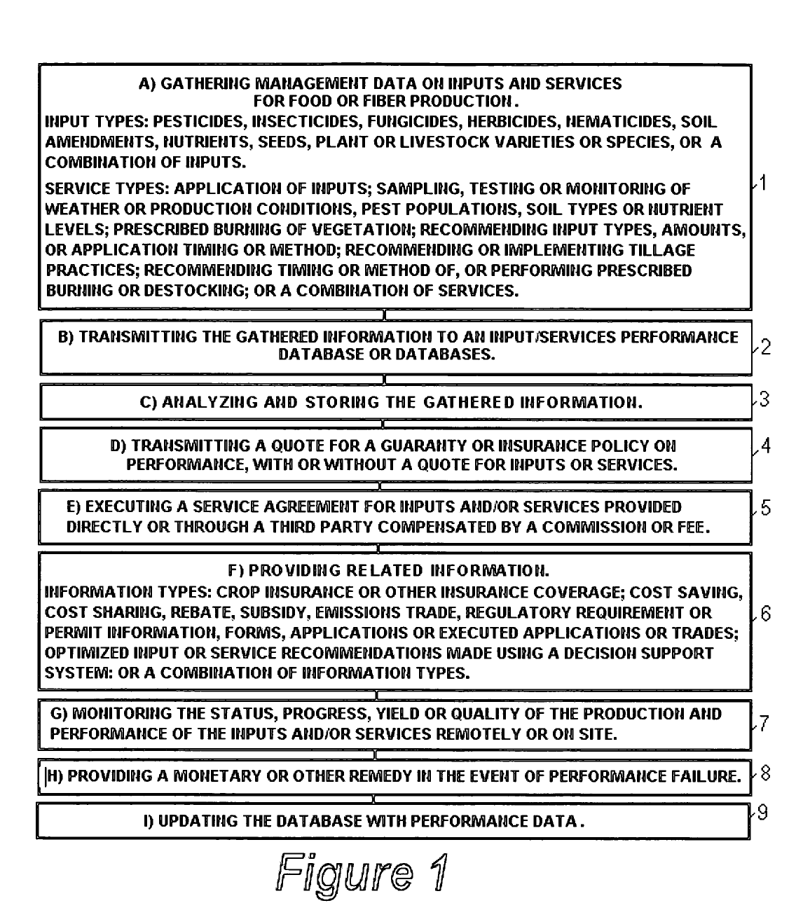

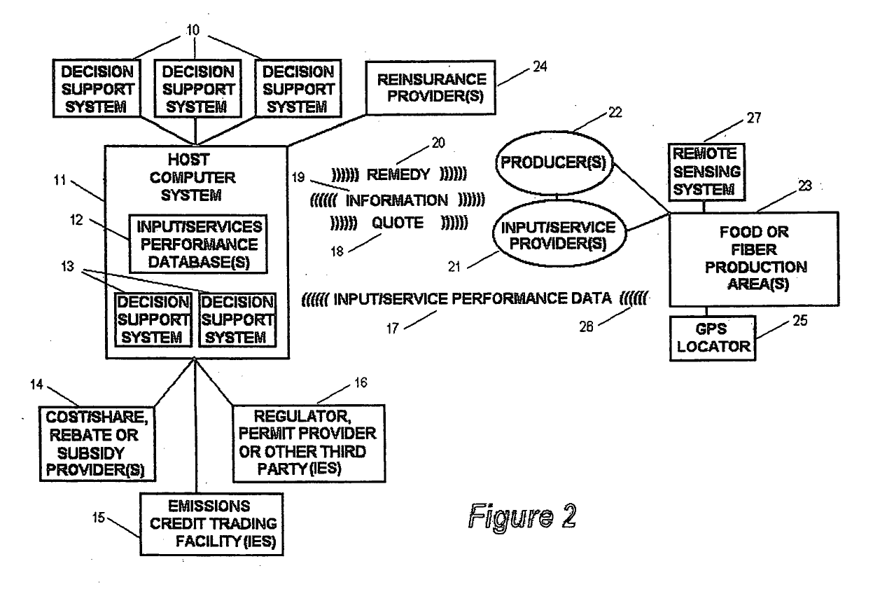

Referring now to the drawings, which are for purposes of illustrating a preferred embodiment of the present invention only, and not for the purposes of limiting the scope of the invention, FIGS. 1 and 2 illustrate a preferred system and method for implementing the present invention.

FIG. 1 is a flow chart of information managed in accordance with one method of the current invention. As applied to the current corn example, for instance, information on a specific corn field or fields would be collected, as at 1, and transmitted, as at 2, via computer, hand-held portable device, wireless device, phone, fax, email, postal mail, or hand delivery and entered into a database. This information will include size and location of the field; soil types within the field; previous, current, and/or expected yields; previous, current, and/or expected fertilizer types (including manures) and application rates and timing; previous crop and crop yield (and quality if alfalfa or soybeans); phosphorus soil test type and results and the lab performing the test.

The IMS will be used to analyze and store these data, as at 3, and to correlate and compare them to those of fields with similar profiles within the database, that data having been collected and entered from university research studies and other farmers' fields. The database may contain the frequency of lower yields resulting from the application of reduced, BMP rates of fertilizer from a plurality of corn producers, production histories, geographic locations, years, climates, weather patterns, soil types, fertilizer types, and BMP systems used. The database may also include weather forecast information for the coming production season. The BMP rate of fertilizer application will be calculated for the site and site-specific conditions using a decision support system, and the expected performance of the BMP rate will be predicted. The IMS will be used to consider previous history of yields for similar fields and conditions, and if available in the database, for that specific field, producer, and input/service provider, and the forecasted weather if available. Related information on cost shares, subsidies, rebates, cost savings, permit requirements, and emissions trading opportunities for the specific location will also be identified and collated.

A quote will be prepared and transmitted, as at 4, back to the user in the form of a customized service contract that will include a price for the fertilizer, application services if requested, and guaranty or insurance policy on performance. The quote will include expected savings using the BMP application rates vs. previously used rates on the specific field, or average rates for the region. The quote will take into account or reference related information, as at 6, including any available cost shares, rebates, subsidies, tax credits, trade opportunities, or plan or permit requirements. The service contract will specify a protocol for applying the fertilizer, including establishing a check, or control strip through the field, that will be fertilized at a rate greater than the BMP rate, and a protocol for comparing the yield at harvest between the check strip and an adjacent strip fertilized at the BMP rate.

The user will accept or reject the contract, or specify desired changes and resubmit for re-quoting. Once accepted, as at 5, the IMS will be used to prepare the appropriate forms and documents, including protocols for implementing the BMPs and monitoring and documenting performance, along with any forms required for cost shares, etc.

To test the performance of the BMP for each farmer, in this example, the farmer would designate two adjacent strips in his or her field and have them prepared, planted, and treated identically in every respect except for the amount of fertilizer applied—the same BMP amount as used on the balance of the field in one strip and a “conventional”, excessive amount in the other, “check” strip. Therefore, any difference in yield between the BMP strip and the conventionally fertilized check strip can be reliably attributed to fertilizer rates of application. The producer will report yields from one pass of the harvesting equipment through the check strip and the adjacent BMP strip, as at 7, and if yields are lower on the BMP strip, may immediately cease harvesting of the remainder of the check strip and the BMP strip and at least portions of the balance of the field and request a formal yield assessment.

If the formal yield assessment of the remaining portion of the check strip and adjacent strip and remaining field portions by an independent adjuster confirms that the performance standard has not been met for the BMP application, a cash or credit remedy will be given, as at 8, in accordance with the terms of the service contract. Performance data will be added to the database, as at 9, and used to improve the IMS and decision-support system's ability to recommend fertilizer amounts and improve predictions of expected losses and pricing.

In use, in another form, the invention provides that a producer will submit information on other BMPs in addition to or in place of nutrient BMPs, for example, the number of corn rootworm beetles observed on plants or captured in monitoring traps the previous season in a specific field or fields. The IMS will be used to provide a quote for corn rootworm management inputs and services such as seed varieties genetically modified to suppress corn rootworm populations or a soil insecticide, or no management inputs and services, plus a guaranty or insurance policy ensuring that corn rootworm larval feeding damage will remain below a specified threshold. A protocol for assessing corn roots for damage against the performance standard, and determining if a remedy is to be made and the form of that remedy, will be specified. The size and configuration of any refuge, created for the purpose of maintaining individual corn rootworms susceptible to the control measure specified, may also be determined and defined in the service agreement.

In use, in yet another form, the invention provides that a producer will submit information on the species, variety, condition, acres, soil types and location of food, feed, fiber or ornamental plant production. The IMS will be used to determine a variable rate of nutrients, pesticides and/or other inputs to be applied to match the within-field variability in input needs (variable rate application), set performance standards and assessment protocols, and quote prices for the input, the variable rate application, and/or the performance guaranty or insurance policy.

In use, in still yet another form, the invention provides that a producer of potatoes will submit information on the variety, acres, and location of potato production. The IMS will be used to determine when fungicides should be applied to reduce the possibility of early blight or late blight disease infestation, set a performance standard and assessment protocol for disease severity and incidence, and quote prices for the fungicide, application of fungicide, and/or performance guaranty or insurance policy.

In use, in a further other form, the invention provides that a producer of field crops will submit information on the species, variety, acres, and locations of field crop production. The IMS will be used to determine which tillage method is optimal for production and soil conservation, set a performance standard and assessment protocol, and quote a price for the tillage operation and/or performance guaranty or insurance policy.

In use, in a yet further other form, the invention provides that a producer of livestock will submit information on the species, breed, age, sex, condition, and/or number of livestock held on grazing or pasture land. The IMS will be used to analyze past performance and past, current and forecasted weather, and determine an optimal stocking rate, set a performance standard and assessment protocol, and quote a price for stocking or de-stocking services and/or a performance guaranty or insurance policy.

In use, in still yet another further form, the invention provides that a producer of livestock will submit information such as the species, breed, age, sex, condition and number of livestock fed, and the amounts of nutrients supplied in animal feed. The IMS will be used to analyze past performance and determine a BMP rate of nutrients to be included in the animal feed, set a performance standard and assessment protocol for production of meat, dairy products, eggs or other product, and/or for reproductive success, and quote a price for the animal feed and/or performance guaranty or insurance policy.

In use, in a final other form illustrated here, the invention provides that a manager of forested land will submit information on tree age; condition; species composition; ground cover; time since last harvested, pruned or cleared; acres, and location of the forest land. The IMS will be used to analyze past performance and previous, current, and forecasted weather to determine the optimal time, if any, for prescribed burning to manage the vegetation and reduce wildfire risk, set a performance standard and assessment protocol, and quote prices for management of the burn and/or a performance guaranty or insurance policy.

Referring now to FIG. 2, a symbolic relational diagram of the present invention, the information management system includes a decision support system(s) 10 external to the host computer system 11 used to determine optimized rates and protocols for inputs and services. An internal performance database 12 contains historical and current performance data for a range of inputs and services, including expected frequency and severity of losses due to failure of the optimized practice, or BMP, specified. Internal decision support systems 13 may be used in place of, or in addition to, the external systems 10.

In generating output to be returned to the user, applicable cost share, rebate, tax credit or subsidy providers and opportunities 14; emissions credit trading facilities and potentials 15; and/or regulatory or permit providers and requirements 16 may be identified and considered when preparing the output. These providers may be given direct access to information stored in the database on executed service agreements, and/or the IMS may be used to provide this information including completed applications and forms. These providers may retrieve information about a specific location, or summary information about a plurality of locations, on a gratis or fee basis. Providers may use this information to improve BMP recommendations, monitor performance of BMPs, cost share, rebate, tax credit, subsidy, and trading or regulatory programs.

The host computer will house the database of performance information 17 generated from each executed contract. These data will be used to improve the accuracy of performance predictions, and of the recommended BMPs generated by the decision support systems.

Quotes 18 will be provided to users within draft commercial service agreements along with other information 19 which will specify inputs to be provided, services to be performed, protocols to be followed when applying inputs and performing services, performance standards, and assessment protocols. Additional information on cost shares, rebates, tax credits, subsidies, emissions credit trading and regulatory requirements will also be referenced and/or factored into the quote. The IMS will be used to administer remedies 20 in the event performance fails to meet the predetermined standard according to the assessment protocol specified.

Users may include input/service providers 21, producers 22 or managers of production. Input and/or service providers will use the system to generate quotes they can offer to their customers and predict their margins or commissions on inputs, services and/or the guaranty or insurance policy. Producers or managers of production will use the system in conjunction with an input/service provider, or directly to purchase inputs and services with guaranteed or insured performance.

Users will transmit information 19 about the specific production, inputs and services to be included in the quote and service agreement, review draft agreements generated using the IMS, suggest revisions, and reject or accept and execute finalize agreements. They will also monitor performance of the production at its location 23 or via remote sensing 27 and request a formal performance assessment if necessary to determine the extent of remedy required, if any.

Third-party insurance or reinsurance providers 24 may link to the system to receive requests for quotes and provide quotes for coverage of the performance guaranty. A GPS locating device 25 may pinpoint the location of the production, or specific locations within the production, such as the location of a check or comparison strip for measuring input and/or service performance. Transmission of information 26 between users and others will be by in-person conversation, phone, fax, mail, courier, electronic mail, computer network, or wireless device.

In view of the foregoing, it is contemplated that the various efficiencies of the methods of the present invention provide substantial incentives for adoption of BMPs and other scientific methods by producers, managers, and input/service providers. These users are protected from short-term economic losses when BMPs and other scientific methods fail, while preserving the long-term benefits.

Additional modifications of and improvements to the present invention may also be apparent to those of ordinary skill in the art. Thus, in particular the combination of steps and devices described and illustrated herein is intended to represent only a few embodiments of the present invention and is not intended to limit alternative steps and devices. Rather, the invention is as broad as indicated by the appended claims.

1. A method of managing information concerning implementation of best management practices in agricultural production, the method comprising the steps of:
a. gathering management data in connection with inputs and services for the production of food, feed, or fiber;
b. transmitting the gathered information to at least one database, each database including information on the performance of those inputs and services under a variety of circumstances, places, and conditions;
c. analyzing and storing the gathered information;
d. transmitting the analysis and a quotation for inputs and/or services including a service loss guaranty or insurance policy on the performance of those inputs and/or services;
e. preparing and executing a commercial service agreement for the inputs and/or services;
f. providing information related to the inputs and services;
g. monitoring status, progress, yield, and other performance measures related to the inputs and/or services;
h. providing a remedy in the event of performance failure; and
i. updating the database with the performance data obtained.

2. The method defined in claim 1 wherein the inputs include a control chemical selected from a group comprising insecticides, fungicides, herbicides, and nematicides.

3. The method defined in claim 1 wherein the inputs comprise soil amendments.

4. The method defined in claim 1 wherein the inputs comprise nutrients selected from a group comprising animal or green manure, commercial fertilizer, and feed supplements.

5. The method defined in claim 1 wherein the inputs comprise one of seeds, plant species, and livestock species.

6. The method defined in claim 1 wherein the inputs are selected from a group comprising control chemicals, soil amendments, nutrients, seeds, plant species, and livestock species.

7. The method defined in claim 1 wherein no inputs are specified or quoted, but where a quotation is provided solely for a performance guaranty or insurance policy.

8. The method defined in claim 1 wherein the services comprise application of inputs.

9. The method defined in claim 1 wherein the services comprise at least one of sampling, testing or monitoring of weather conditions, production conditions, pest populations, soil types, nutrient levels, and prescribed burning of vegetation.

10. The method defined in claim 1 wherein the services comprise recommending at least one of input types, amounts, application timing, and application method.

11. The method defined in claim 1 wherein the services comprise at least one of recommending and implementing tillage practices.

12. The method defined in claim 1 wherein the services comprise at least one of recommending timing and method of, and performing, controlled burning of vegetation.

13. The method defined in claim 1 wherein the services comprise at least one of recommending timing and method of, and performing, destocking of livestock.

14. The method defined in claim 1 wherein the services comprise a combination of at least one of application, sampling, testing, monitoring, and recommendation of inputs.

15. The method defined in claim 1 wherein the commercial service agreement includes one of a sales commission and a fee for service to a third-party vendor who will deliver and/or apply the quoted products and services.

16. The method defined in claim 1 wherein federal crop insurance coverage or other insurance on the production that may cover all or a portion of a service loss is gathered and considered and referenced in one of the quote, the commercial service agreement, and information provided.

17. The method defined in claim 1 wherein input and service cost savings, cost-shares, rebates, tax credits, and subsidies available to one of the producer and the input or service provider are included or referenced in a quotation, and information or application forms for obtaining same are included in the output, entered into the database, or automatically submitted for redemption on behalf of the producer or the input or service provider.

18. The method defined in claim 1 wherein emissions trading credits available to the producer or input or services provider are included or referenced in a quotation, and information or application forms for obtaining those trading credits are included in the output, entered into the database, or automatically executed on behalf of the producer or the input or service provider.

19. The method defined in claim 1 wherein permit or regulatory compliance requirements applicable to the producer or to the input or services provider are included or referenced, and information or application forms for obtaining those permits or meeting those compliance requirements are included in the output, entered into the database, or automatically executed on behalf of the producer or the input or service provider.

20. The method defined in claim 1 wherein at least one of the databases includes recommended input application and service practices, or links to a decision support system that outputs recommended input application and service practices back to the database for transmission to the producer or the input or service provider.

21. The method defined in claim 1 wherein the information provided comprises one or more of information on crop insurance or other coverage; cost savings, cost sharing, rebate, subsidy, trade opportunities, permit or other regulatory requirements, application forms, executed applications, executed trades; and optimized input and service recommendations.

22. The method defined in claim 1 wherein the service loss guaranty or insurance policy comprises a remedy for losses resulting from failure of the recommended inputs or services.

23. The method defined in claim 1 wherein at least one database includes a current cost for reinsurance coverage on the service loss guarantee or insurance policy and the method considers that cost when determining a quotation for inputs and services.

24. The method defined in claim 1 wherein the information system communicates electronically with insurance or reinsurance sources, obtains a current price for insurance or reinsurance, and considers the current reinsurance price in determining a quotation for the service loss guaranty.

25. The method defined in claim 1 wherein information about the status, progress, yield and/or quality of the plant or livestock production are entered into the information management system to predict expected losses, determine service guaranty or insurance policy payments to the producer, manager or input/service provider, or report to regulatory agencies, providers of cost shares or subsidies, emissions credit trading facilities or others.

26. The method defined in claim 1 wherein information about the status, progress, yield and/or quality of the plant or livestock production is gathered remotely via satellite, aerial, infrared, digital or other photography or imaging.

27. The method defined in claim 1 wherein the gathered information is transmitted to and received by a computer network, handheld computer, portable computer and/or wireless device.

28. The method defined in claim 1 wherein the gathered information includes location information generated using a global positioning system (GPS)-based device.

29. The method defined in claim 1 wherein a third party comprising one of a regulator, cost share or subsidy provider, or emissions credit trading facility is given direct access to data from the database for a fee or other consideration.

30. The method defined in claim 1 wherein the user of the information system is one of a producer and a manager of food, feed, fiber, or livestock production.

31. The method defined in claim 1 wherein the user of the information system is one of an input provider and a service provider to producers and managers of production.
